(19) United States
(12) Patent Application Publication
(10) Pub. No.: US 2008/0276774 A1
(43) Pub. Date: Nov. 13, 2008

(54) Sheet metal section

(75) Inventor: Kurt Andersson, Vargon (SE)

Correspondence Address: HARNESS, DICKEY & PIERCE, P.L.C., P.O. BOX 828, BLOOMFIELD HILLS, MI, 48303, US

(73) Assignee: Saab Automobile AB, Trollhaettan (SE)

(21) Appl. No.: 12/002,284

(22) Filed: Dec. 14, 2007

Related U.S. Application Data
(62) Division of application No. 10/708,259, filed on Feb. 20, 2004, now abandoned.

(51) Int. Cl. B26D 3/00

(52) U.S. Cl. 83/50

(57) ABSTRACT

A method of cutting a strip of sheet metal, including feeding out a continuous strip of sheet metal in a feeding direction, cutting the strip into a plurality of lengths, including making a wave shaped cut between each length and an adjacent length, wherein each of a forward edge and a following edge of each length include a plurality of waves, and selecting at least one of a radius of each of the plurality of waves and a spacing between adjacent ones of the plurality of waves based on a cutting angle, wherein the cutting angle is oblique with respect to the feeding direction.

### CROSS-REFERENCE TO RELATED APPLICATIONS

This application is a divisional of U.S. patent application Ser. No. 10/708,259 filed on Feb. 20, 2004. The disclosure of the above application is incorporated herein by reference.

### BACKGROUND OF INVENTION

1. Field of the Invention

The present invention relates to a method for cutting a continuous strip of sheet metal into finite length sections. The invention also relates to such a finite length section.

2. Description of Related Art

In a variety of manufacturing industries sheet metal is used. The sheet metal normally arrives at the manufacturing industry stored in coils comprising a continuous strip of sheet metal. Coiled sheet metal facilitate transportation and can be purchased in a variety of lengths, widths, thickness and material. However, before the sheet metal can be further machined, the continuous strip must be cut into finite lengths. For this purpose, machines for shearing, slitting and sawing a continuous strip of sheet metal into sections of finite lengths with linearly sheared, slit or sawn edges are known in the art.

To avoid excessive material wastage it is essential that the continuous strip of sheet metal are sheared, slit or sawn into sections which are not longer than required in the subsequent machining operation, e.g. a pressing operation. When the manufacturing volumes are high, even small length savings per section are essential.

However, during the subsequent pressing operation the outermost edge portion of the cut sections have to be firmly held by means of a holder device before the pressing tool is allowed to strike the sheet metal. Thus, the sections are made longer than if no such holding was required. Since these holder surfaces are cut off upon completion of the pressing operation they are considered as wastage.

Accordingly, related art methods for preparing finite length sections from a coiled continuous strip of sheet metal, which is to be used in a subsequent pressing operation, imply that sheet metal has to be rejected.

### OBJECT OF THE INVENTION

The object of the invention is to provide finite length sections from coiled sheet metal with a minimum of material wastage.

### SUMMARY OF INVENTION

This object is achieved by means of a method comprising the steps of feeding out a continuous strip of sheet metal, and cutting the continuous strip into sections of finite lengths, wherein the cutting step is characterized by cutting the continuous strip into sections of finite lengths having wave shaped edge portions. The object is also achieved by means of a finite length section of sheet metal being fed out and cut from a continuous strip, the section comprising first edge portions being parallel with the feeding direction of the continuous strip, and second edge portions being transverse the feeding direction of the continuous strip, wherein the second edges portions are wave shaped.

Due to the wave shape of the edge portions, sheet metal material is saved since less material need to be rejected. By means of the method it is possible to provide finite length sections having wave shaped edge portions of the same length as if the sections were provided with linear straight edge portions, at the same time as material is saved. The reason is that the wave shaped edge portions of two, in the feeding direction, consecutive sections overlap each other. Thus, for every cut a distance corresponding to the height of the wave shaped, i.e. the over-lapping distance is saved. When production volumes are high a lot of material may be saved.

Moreover, if the cutting step is followed by the step of firmly holding the wave shaped edge portions in a subsequent sheet metal section machining operation, e.g. a pressing operation, the holder tool will be subjected to less wear if the edge portions are wave shaped instead of linear. The reason is that when the edge portions are wave shaped the material can more easily deform during the strike of the pressing tool. When the edge portions are linear such deformation is not possible to the same extent, so instead the holder tool will absorb the corresponding deformation forces.

Suitably, the wave shape is coplanar with the plane of the section, and the wave shaped edge portions comprise a plurality of mutually spaced notches.

Preferably, the notches have a height in the feeding direction in the interval 10-50 mm. Hereby, sections having wave shaped edge portions falling within this interval are suitable for many applications within car body manufacturing.

Suitably, the wave shape is sinusoidal. Hereby, tool manufacturing is simplified at the same time as a continuous, smooth cut is provided.

### BRIEF DESCRIPTION OF DRAWINGS

The invention will now be described with reference to accompanying drawings, on which:

FIG. 1 shows a front view of a portion of a continuous strip of sheet metal to be cut into finite length sections according to related art.

FIG. 2 shows a front view of a portion of a continuous strip of sheet metal to be cut into finite length sections according to the present invention.

FIG. 3 shows a front view of a portion of a continuous strip of sheet metal to be cut into finite length sections having obliquely cut wave shaped edge portions.

FIG. 4 shows a close-up view of the area enclosed by the circle in FIG. 3.

FIG. 5 is a flow chart of a method according to an example embodiment of the present invention.

### DETAILED DESCRIPTION

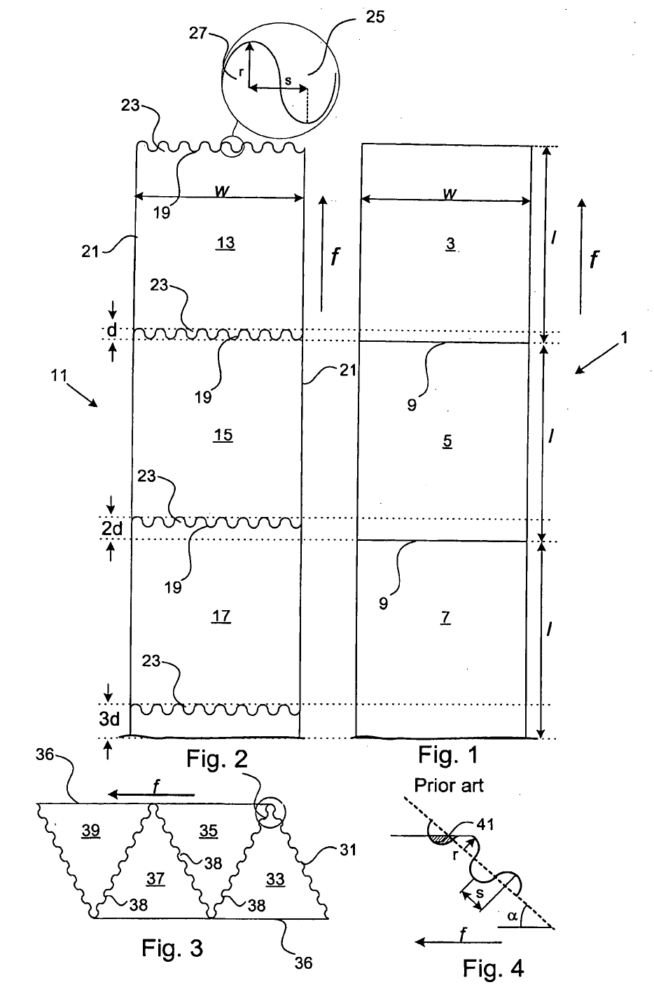

FIG. 1 shows a portion of a continuous strip 1 of sheet metal. A related art method for cutting such strips will now be described. The strip is fed out from a coil of sheet metal in the direction of arrow f (the coil itself is not shown, but it is understood that it should be located below the strip as positioned in the figure). The strip is to be cut into three finite length sections 3, 5, 7, each having a length l and a width w. When a length l of the strip 1 has been fed out from the coil, a not shown cutting tool cuts the continuous strip along a straight line 9 and separates the cut section 3 from the rest of the continuous strip 1. This cut section 3 is removed and yet a length l is fed out and yet a section 5 is cut off This procedure is repeated as many times as desired, and the cut off sections are ready for further machining.

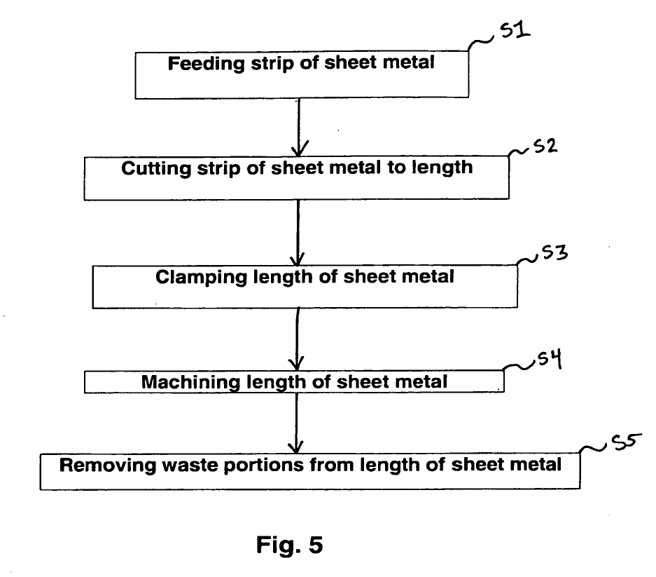

FIG. 2 shows a portion of a continuous strip 11 of sheet metal. The method according to the invention for cutting such strips will now be described. The strip is fed out (S1 in FIG. 5) from a coil of sheet metal in the direction of arrow f (the coil itself is not shown, but it is understood that it should be located below the strip as positioned in the figure). The strip is cut into three finite length sections 13, 15, 17, each having a length l and a width w. When a length of the strip has been fed out from the coil, a not shown cutting tool cuts the continuous strip 11 (S2 in FIG. 5) along a wave shaped line 19 and separates the cut section 13 from the rest of the continuous strip 11. This cut section 13 is removed and yet a length l is fed out and yet a section 15 is cut off. This procedure is repeated as many times as desired, and the cut off sections are ready for further machining.

Each finite length section 13, 15, 17 has first edge portions 21 which are parallel with the feeding direction f of the continuous strip, and second edge portions 23 which are transverse to the feeding directions The second edge portions 23 of the section comprise mutually spaced notches 25 and projections 27, which alternately extend between the first edge portions 21 of the section, thus forming the wave shape 23. The wave shape is in this embodiment sine waved, but is conceivable to adopt other wave shapes, such as square shaped waves or saw-toothed waves. Each sine shaped notch/projection has a radius r and the spacing between two adjacent notches/projections is denoted 2s (in FIG. 2, only half the spacing s is shown).

When comparing the figures, it should be apparent that the lengths l of the sections, irrespective of the form of the edge portions, are equal. Still, the amount of sheet metal required for producing the sections 3, 5, 7, 13, 15, 17 of finite length is greater when utilizing the related art solution (FIG. 1) compared to the inventive method (FIG. 2). The reason is that from a continuous strip 11 of sheet metal a length corresponding to the radius r of the notches 25 is saved for every cut, since the wave shaped edge portions 23 of two consecutive sections overlap, i.e. engage with each other. Accordingly, a total length of d is saved after the first cut off section 13, a total length of 2d is saved after the second cut off section 15, and a total length of 3d is saved after the third cut off section 17. Thus, by utilizing wave shaped edge portions 23 a lower consumption of sheet metal material is promoted.

These cut off sections are ready for further machining operations, e.g. a pressing operation. In such cases, the edge portions 23 of the sections 13, 15, 17 have to be firmly held or clamped before the pressing tool is allowed to strike the sheet metal, otherwise the section would not be properly pressed. (S3 and S4 in FIG. 5) A not shown holder device provides for the holding or clamping of the edge portions 23. When pressing is completed, these held edge portions 23 are considered as wastage and are rejected (S5 in FIG. 5).

In addition to the material saving advantage, tool wear is decreased when the sections are provided with wave shaped edge portions, which in turn improves working life of the holder device. The reason is that mechanical stresses on the holder device is less during the pressing operation if the edge portions are wave shaped instead of linear, since the wave shape more easily can deform during the pressing tool strike compared with the linear form. When the sections are provided with linear cuts, such deformation does not occur as easily and the holder device must absorb the forces concerned.

FIG. 3 shows yet an embodiment of the invention. Instead of cutting the continuous strip of sheet metal perpendicularly to the feeding direction as in FIG. 2, these cuts 31 are cut obliquely to a feeding direction f, thus forming triangular sections 33, 35, 37, 39 having first edge portions 36 which are parallel with the feeding direction f of the continuous strip, and second edge portions 38 which are transverse to the feeding direction f.

Obliquely cut sections (swivelling cuts) are known in the art, but not in combination with the wave shaped cuts 31. Accordingly, the same principles apply as for the embodiment relating to FIG. 2. Such oblique cuts are motivated when only a portion of the section are to be used during the pressing operation, e.g. a triangular or tapered part. The purpose is to minimize material wastage.

FIG. 4 shows an enlargement view of a portion of the area enclosed by the circle in FIG. 3. The cuts form an angle a with the feeding direction. For some angles a, and if the height of the notches or the projections, i.e. in this case the radius r of the wave shape is greater than half the distance between two adjacent notches, i.e. s, it is possible that a small piece 41 of sheet metal (indicated by the hatched area) is cut free, since the tool cuts the first edge portion 36 of a section at two locations. Such small pieces 41 can cause problems to the cutting tool if they are accumulated in the cutting machine and should therefore be avoided. However, these small sheet metal pieces 41 can be avoided if the relationship between the height of the notches, i.e. the radius r of the wave shape and the spacing between two adjacent notches is adapted to the chosen angle a.

Even though it is possible to use different cutting tools for creating wave shapes in a variety of sizes in dependence of the width and length of the coiled sheet metal strips to be used, it is not always realistic to choose such a solution since cutting tools are expensive to manufacture. Instead, it is likely that one or a few numbers of cutting tools are used in several applications. Accordingly, the size of the wave shaped created by the cutting tool will be a compromise depending on the pressed products in the manufacturing process.

It is preferable that for car body manufacturing, cutting tool which forms wave shapes having notches with a height in the interval 10-50 mm are used, and more preferable in the interval 20-30 mm, and most preferable 25 mm. As mentioned above, these measures are preferably equal to or less than half the distance between adjacent notches.

What is claimed is:

1. A method of cutting a strip of sheet metal comprising:
feeding out a continuous strip of sheet metal in a feeding direction;
cutting the strip into a plurality of lengths, including making a wave shaped cut between each length and an adjacent length, wherein each of a forward edge and a following edge of each length include a plurality of waves; and
selecting at least one of a radius of each of the plurality of waves and a spacing between adjacent ones of the plurality of waves based on a cutting angle,
wherein the cutting angle is oblique with respect to the feeding direction.

2. The method of claim 1 further comprising:
machining an exposed portion of each length while clamping the plurality of waves of the wave shaped forward and following edges; and
removing and rejecting the wave shaped forward and following edges from each sheet metal length after machining.

3. The method of claim 1, wherein the plurality of waves are in a sinusoidal arrangement.

4. The method of claim 1 wherein the plurality of waves are at least one of square shaped and saw-tooth shaped.

5. The method of claim 1 wherein a height of each of the plurality of waves is less than or equal to 50 mm.

6. The method of claim 5 wherein the height is between 20 and 30 mm.

7. The method of claim 6 wherein the height is 25 mm.

8. The method of claim 1 wherein a height of each of the plurality of waves is less than or equal to a distance between midpoints of adjacent ones of the plurality of waves.

9. The method of claim 2 wherein the machining includes at least one of stamping, pressing, and die cutting.

10. The method of claim 1 wherein each of the lengths is triangular.

11. The method of claim 1 wherein the feeding includes feeding the continuous strip of sheet metal from a coil.
